(19) United States
(12) Patent Application Publication
(10) Pub. No.: US 2013/0174418 A1
(43) Pub. Date: Jul. 11, 2013

(54) METHOD OF MANUFACTURING CABLE ASSEMBLY

(71) Applicant: FUJIKURA LTD., Tokyo (JP)

(72) Inventor: Shigeru KOJIMA, Sakura-shi (JP)

(73) Assignee: FUJIKURA LTD., Tokyo (JP)

(21) Appl. No.: 13/782,617

(22) Filed: Mar. 1, 2013

Related U.S. Application Data
(63) Continuation of application No. PCT/JP2011/065685, filed on Jul. 8, 2011.

(30) Foreign Application Priority Data
Sep. 2, 2010 (JP) 2010-196373

(51) Int. Cl. H01B 13/00

(52) U.S. Cl. CPC H01B 13/0036
USPC 29/858

(57) ABSTRACT

An object of the present invention is to provide a cable assembly manufacturing method of manufacturing a cable assembly which has the water cutoff property and of which insertion holes can be attached to small housings. A method of manufacturing a cable assembly includes: a bundling process of bundling a plurality of cables; a molding step of providing a pair of seal caps on outer peripheral surfaces of the plurality of bundled cables by way of insertion molding; an inserting step of inserting a portion of the plurality of cables between the seal caps in a water-proof tube having a stretching property; a covering step of covering the seal caps by the both ends of the water-proof tube water-tight; and a connecting step of connecting connectors to the both ends of the plurality of cables.

### TECHNICAL FIELD

The present invention relates to a method of manufacturing a cable assembly and, more particularly, a method of manufacturing a cable assembly which has the water cutoff property and of which insertion holes can be attached to small housings.

### BACKGROUND ART

There are some small electronic devices typically such as mobile telephones which are provided with a display portion and an operating portion as separate portions which can be folded through hinges. To electrically connect the display portion and the operating portion of such a small electronic device, a cable assembly is used which is made by bundling a plurality of extremely thin coaxial cables and integrating both ends of the coaxial cables with connectors. In this case, the cable assembly is laid in the housing in which the display is provided, by being guided through a hinge from a housing in which the operating portion is provided.

By the way, in recent years, there is a case where small electronic devices are required to have the water-proof property. Hence, the above small electronic devices are each required to have the water cutoff property between the housing in which the operating portion is provided and the cable assembly, and the water cutoff property between the housing in which the display is provided and the cable assembly.

In the cable assembly disclosed in following Patent Document 1, a plurality of bundled cables are guided through a water-proof tube and penetration holes of tubular seal caps. Further, ends of the water-proof tube cover portions of outer peripheral surfaces of the seal caps water-tight, and O rings are attached to the other portions of the outer peripheral surfaces of these seal caps. Furthermore, in a state where the cables are inserted in the insertion holes provided in the housings, the seal caps to which the O rings are attached are pressed fit in the insertion holes of the housings to cut off water between the seal caps and the housings. Still further, the ends of the water-proof tube cover the seal caps water-tight, so that penetration of water from the penetration holes of the seal caps is also prevented.

### CITATION LIST

### Patent Document

[Patent Document 1] Japanese Patent Application Laid-Open No. 2009-206043

### SUMMARY OF INVENTION

### Objects to be Achieved by the Invention

In recent years, small electronic devices such as mobile telephones are further made smaller, and insertion holes in which seal caps are inserted tend to become small. However, to manufacture a cable assembly disclosed in above Patent Document 1, a plurality of bundled cables is guided through a water-proof tube and seal caps. Hence, clearance is required between the seal caps and the cables and inner diameters of the seal caps need to be made wider, and therefore the seal caps become larger. When insertion holes of the cable assembly in housings are small, there is a problem that it is difficult to attach the cable assembly to the housings.

It is therefore an object of the present invention to provide a cable assembly manufacturing method of manufacturing a cable assembly which has the water cutoff property and of which insertion holes can be attached to small housings.

### Means for Achieving the Objects

To solve such a problem, a method of manufacturing a cable assembly according to the present invention includes: a bundling step of bundling a plurality of cables; a molding step of providing a pair of seal caps on outer peripheral surfaces of the plurality of bundled cables by way of insertion molding; an inserting step of inserting a portion of the plurality of cables between the seal caps in a penetration hole of a water-proof tube having a stretching property; a covering step of covering the seal caps by the both ends of the water-proof tube water-tight; and a connecting step of connecting connectors to the both ends of the plurality of cables.

According to this method of manufacturing the cable assembly, a pair of seal caps are provided to a plurality of bundled cables by way of insertion molding, so that little clearance is produced between the seal caps and the cables. Consequently, compared to tubular seal caps which are molded in advance and in penetration holes in which a plurality of cables is inserted, the seal caps can be made smaller. Consequently, even when the housings have small insertion holes of the cable assembly, it is possible to insert the seal caps in the penetration holes of the housings, and attach the seal caps to the housings. Further, in the cable assembly manufactured by this method of manufacturing the cable assembly, the cables between a pair of seal caps are inserted in the water-proof tube which covers the seal caps water-tight, and consequently has the water cutoff property. Consequently, even when a portion between the seal caps is exposed to water, it is possible to prevent water from proceeding between the cables and penetrating toward the connectors.

Further, the method of manufacturing the cable assembly according to the present invention includes: a bundling step of bundling a plurality of cables; an inserting step of inserting a portion of the plurality of bundled cables in a longitudinal direction in a penetration hole of a water-proof tube having a stretching property; a molding step of providing at both ends of the water-proof tube a pair of seal caps on outer peripheral surfaces of the plurality of bundled cables by way of insertion molding; a covering step of covering the seal caps by the both ends of the water-proof tube water-tight; and a connecting step of connecting connectors to the both ends of the plurality of cables.

This method of manufacturing the cable assembly can also manufacture a cable assembly which has the water cutoff property and insertion holes of which can be attached to small housings. Further, a plurality of cables is inserted through the water-proof tube before the seal caps are provided, so that a plurality of cables can be easily inserted through the water-proof tube without inserting a plurality of cables through the water-proof tube such that the water-proof tube goes over the seal caps in the inserting process. Consequently, it is possible to reduce a load on the water-proof tube.

Further, in the method of manufacturing the cable assembly, the connecting step is preferably performed prior to the molding step.

According to this method of manufacturing the cable assembly, a plurality of cables is connected to connectors before the seal caps are provided, so that the seal caps are not bothersome in the connecting process and it is possible to prevent incorrect connection.

Further, in the method of manufacturing the cable assembly, the connecting step is preferably performed prior to the bundling step.

According to this method of manufacturing the cable assembly, the cables are connected to the connectors in a state where a plurality of cables is not bundled, so that it is easy to distinguish between the cables in the connecting process and it is possible to prevent incorrect connection.

Further, in the method of manufacturing the cable assembly, cross-sectional shapes of outer peripheral surfaces in at least a part of portions of the seal caps which are not covered by the water-proof tube are preferably non-circular.

When the cable assembly manufactured by this method of manufacturing the cable assembly is arranged in the housings, the non-circular cross-sectional portions fit to the insertion holes of the housings, so that it is possible to prevent the cable assembly from rotating with respect to the housings.

### Effect of the Invention

As described above, the present invention provides a cable assembly manufacturing method of manufacturing a cable assembly which has the water cutoff property and of which insertion holes can be attached to small housings.

### BRIEF DESCRIPTION OF THE DRAWINGS

FIG. 1 is a plan view illustrating a cable assembly manufactured by a cable assembly manufacturing method according to a first embodiment of the present invention.

FIG. 2 is a view illustrating a structure in a cross section along a II-II line in FIG. 1.

FIG. 3 is a view illustrating a structure in a cross section along a III-III line in FIG. 1.

FIG. 4 is a view illustrating a use state of the cable assembly.

FIG. 5 is a flowchart illustrating a process of the cable assembly manufacturing method according to the first embodiment.

FIG. 6 is a view illustrating a state after a bundling process.

FIG. 7 is a view illustrating a state after a molding process.

FIG. 8 is a view illustrating a state of an inserting process.

FIG. 9 is a view illustrating a state after a covering process.

FIG. 10 is a view illustrating a state after an inserting process according to a second embodiment.

FIG. 11 is a view illustrating a state after a forming process according to the second embodiment.

FIG. 12 is a view illustrating a state after a connecting process according to a third embodiment.

FIG. 13 is a view illustrating a state after a forming process according to the third embodiment.

FIG. 14 is a view illustrating a state after an inserting process according to the third embodiment.

### EMBODIMENT OF THE INVENTION

Preferred embodiments of a method of manufacturing a cable assembly according to the present invention will be described below in detail with reference to the drawings.

### First Embodiment

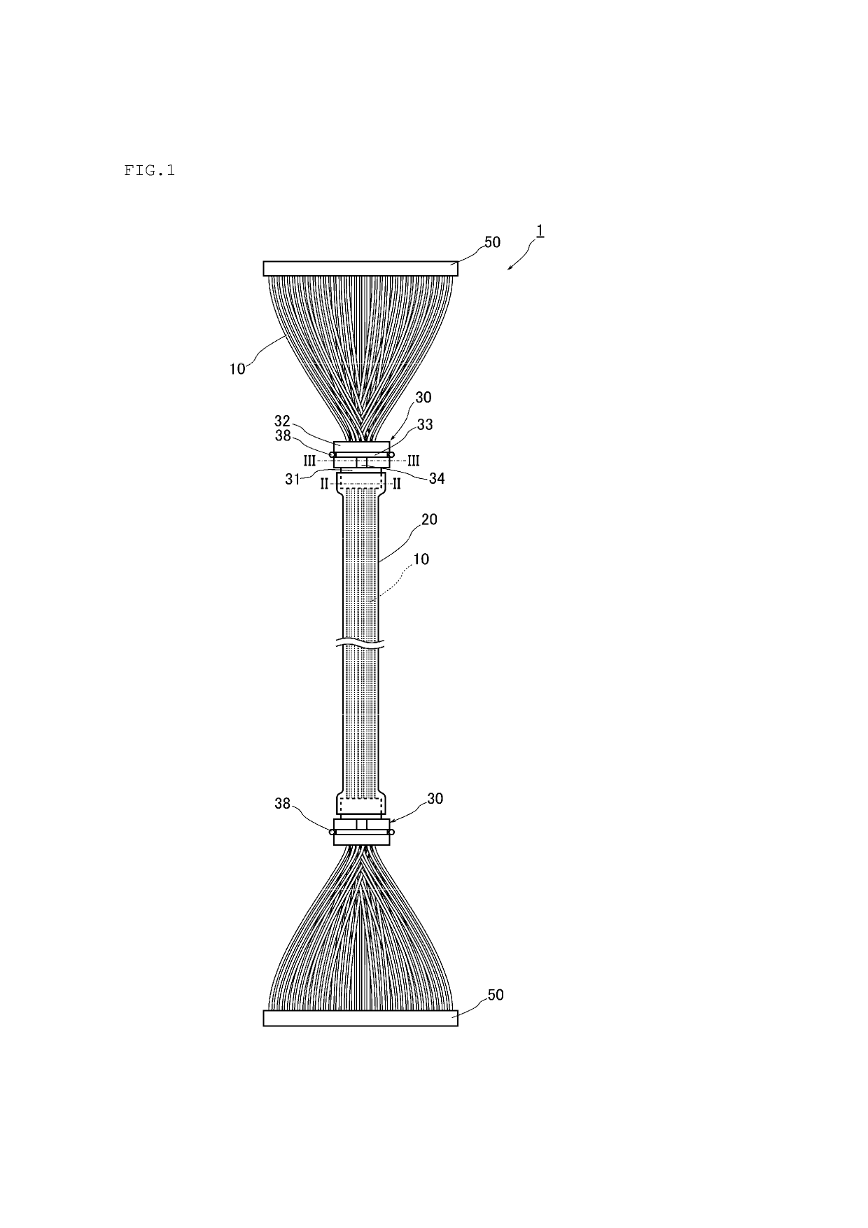

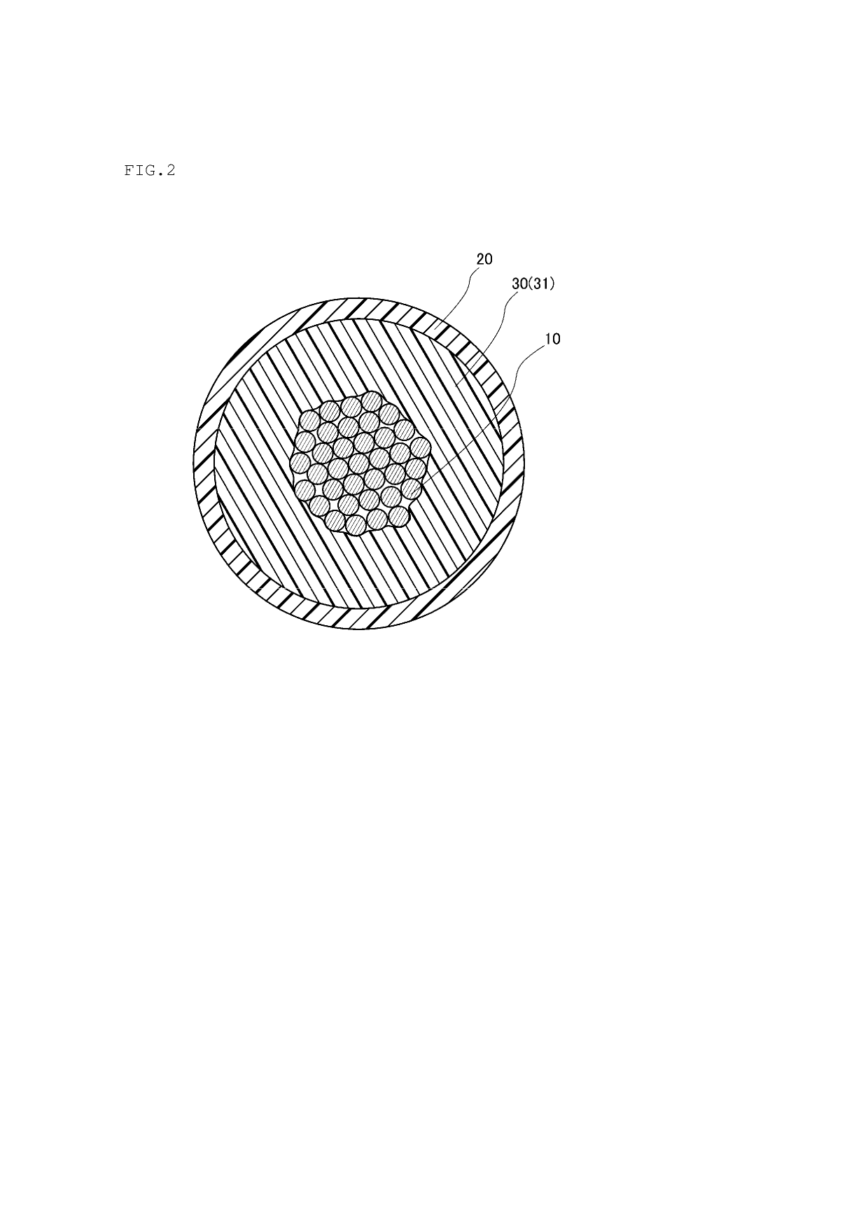

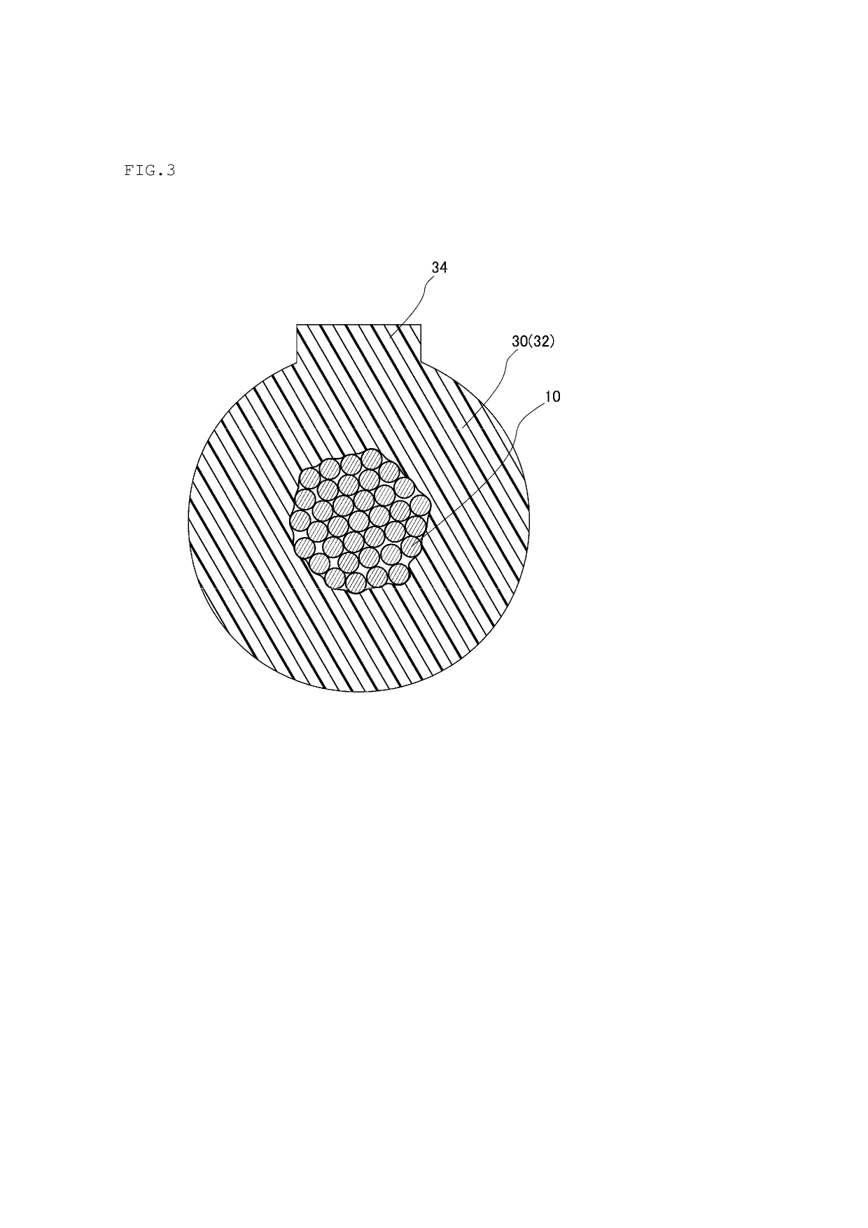

FIG. 1 is a plan view illustrating a cable assembly manufactured by a cable assembly manufacturing method according to a first embodiment of the present invention, FIG. 2 is a view illustrating a structure in a cross section along a II-II line in FIG. 1 and FIG. 3 is a view illustrating a structure in a cross section along a III-III line in FIG. 1.

As illustrated in FIG. 1, a cable assembly 1 mainly has a plurality of bundled cables 10, a pair of seal caps 30 provided on outer surfaces of a plurality of bundled cables 10, a water-proof tube 20 which covers a plurality of cables 10 between a pair of seal caps 30 and a pair of connectors 50 connected to both ends of a plurality of cables.

Each cable 10 is a coaxial cable or an insulation cable. When the cable 10 is the coaxial cable, the cable 10 has a center conductor which is formed with stranded wires of a conductor, an inner insulation layer which is made of insulating resin and covers an outer peripheral surface of the center conductor, an outer conductor which is formed with a metal braid or a metal tape and is provided on an outer peripheral surface of the inner insulation layer and a sheath which covers an outer peripheral surface of the outer conductor and is made of insulation resin. Further, when the cable 10 is the insulation cable, the cable 10 has the same center conductor as that of the coaxial cable, and an insulation layer which covers an outer peripheral surface of the center conductor and is made of insulation resin. In addition, details of a configuration such as the center conductor are not illustrated in FIGS. 2 and 3 for ease of understanding.

As illustrated in FIGS. 1 to 3, each cable 10 formed as described above is bundled at portions at which the seal caps 30 are provided and between the seal caps 30.

As illustrated in FIG. 1, each seal cap 30 has a tubular shape, and has a small diameter portion 31 and a large diameter portion 32 coupled to the small diameter portion 31 in the longitudinal direction. Further, as illustrated in FIG. 2, the small diameter portion 31 has a circular cross-sectional shape which is vertical in the longitudinal direction. That is, the small diameter portion 31 has a cylindrical shape. Further, the large diameter portion 32 has circular and non-circular cross-sectional shapes which are vertical in the longitudinal direction. More specifically, a groove portion 33 is formed on an outer peripheral surface of the large diameter portion 32. Further, on a side closer to the small diameter portion 31 than the groove portion 33 and opposite to the small diameter portion 31 side, a cross-sectional shape which is vertical in the longitudinal direction is circular and, on a side closer to the small diameter portion 31 side than the groove portion 33, a convex portion 34 is formed on the outer peripheral surface as illustrated in FIG. 3 and a cross-sectional shape which is vertical in the longitudinal direction is non-circular. Furthermore, an O ring 38 formed using an elastic material such as silicon rubber is attached to the groove portion 33. In addition, in each drawing, the O rings 38 are illustrated as cross sections for ease of understanding.

Further, the large diameter portions 32 of the seal caps 30 are arranged orienting toward ends of the cables 10, and part of a plurality of bundled cables 10 in the longitudinal direction are accommodated in penetration holes. In addition, almost no clearance is formed between an inner wall surface of the seal cap 30 and a plurality of cables 10.

The water-proof tube 20 is a tube using a material having the stretching property such as silicon rubber. A plurality of cables 10 is accommodated in the penetration holes of the water-proof tube 20 between the seal caps 30 and, as described above, the water-proof tube 20 covers a plurality of cables 10 at a portion between a pair of seal caps 30. Further, as illustrated in FIGS. 1 and 2, both ends of the water-proof tube 20 cover the small diameter portions 31 of the seal caps 30 water-tight. Although the small diameter portion 31 of the seal cap 30 and the end of the water-proof tube 20 may be fixed only by a stretching force of the water-proof tube 20, adhering the small diameter portion 31 of the seal cap 30 and the end of the water-proof tube 20 by means of an adhesive which is not illustrated can prevent the water-proof tube 20 from detaching from the seal cap 30 and is preferable from a view point of improving water-tightness. In addition, the water-proof tube 20 is preferably made of a light transmissive material from a view point of allowing observation of the cables 10 in the penetration holes of the water-proof tube 20.

Each connector 50 has a plurality of terminals which are not illustrated, and these terminals are connected with conductors of the cables 10. When, for example, the cable 10 is the coaxial cable, the center conductor of each cable 10 is connected to a signal terminal of the connector, and the outer conductor of each cable 10 is connected to a ground terminal of the connector. This ground terminal is a terminal to which the outer conductors of the cables 10 are commonly connected.

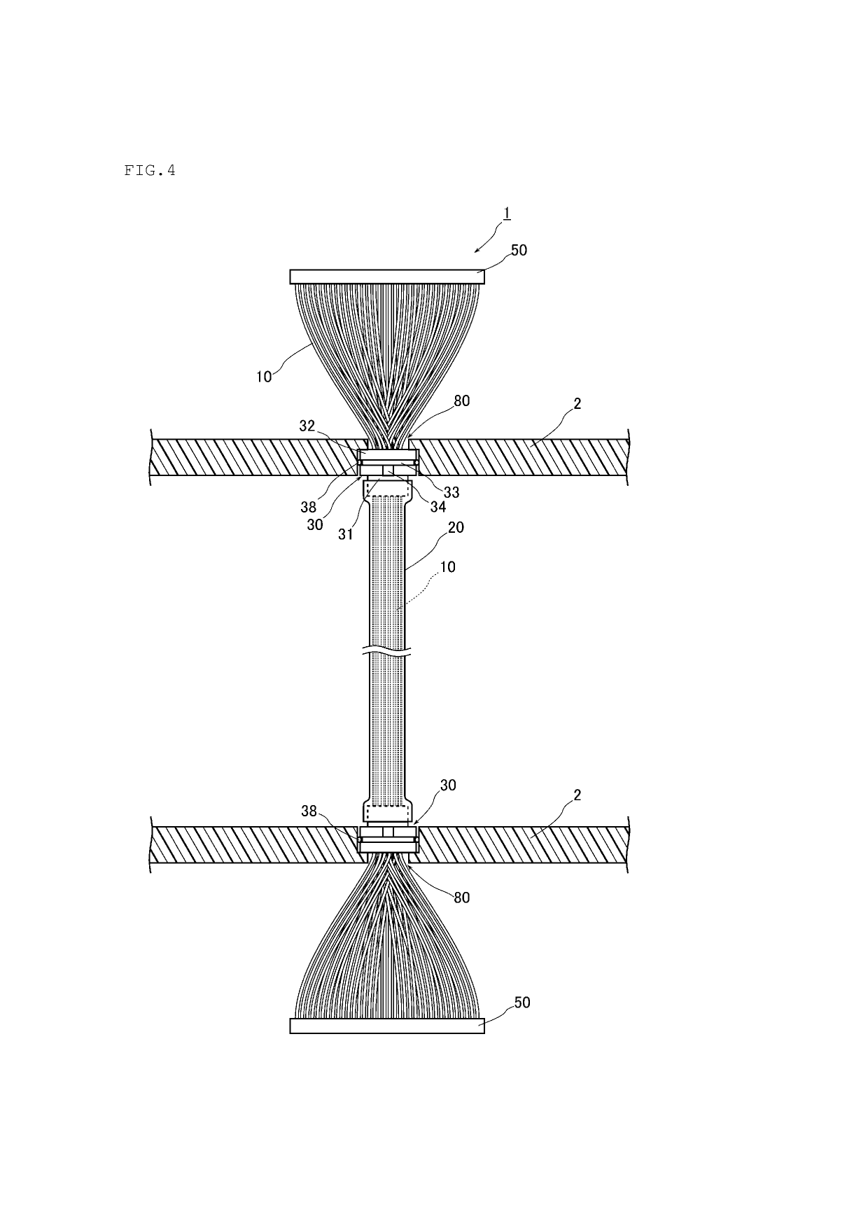

Next, a use state of this cable assembly 1 will be described. FIG. 4 is a view illustrating a use state of the cable assembly 1. More specifically, FIG. 4 is a view illustrating that the cable assembly 1 is arranged from an inside of one housing 2 of the two housings 2 and 2 to an inside of the other housing 2. The housings 2 are not limited in particular, and, in case of, for example, a flip mobile telephone, one housing 2 is a housing in which operation buttons are accommodated, and the other housing 2 is a housing in which a display is accommodated. As illustrated in FIG. 4, in each housing 2, an insertion hole 80 in which the cable assembly 1 is inserted in formed. This insertion hole 80 forms a hole of a small diameter on an inner wall side of the housing 2 and a hole of a large diameter on an outer wall side of the housing 2. Further, in the inner wall surface in which a large diameter hole of the insertion hole 80 is formed, a cutout portion which is not illustrated and to which the convex portion 34 of the seal cap 30 can fit is formed. Further, each connector 50 is inserted inside each housing 2 through the insertion hole 80. Furthermore, each seal cap 30 is pressed fit in the large diameter hole of the insertion hole 80, and the O ring 38 seals between the seal cap 30 and the housing 2 water-tight. Still further, the convex portion 34 of the seal cap 30 fits to the above cutout portion which is not illustrated. Thus, a plurality of cables 10 is led outside once from an inside of one housing 2, and are led to the inside of the other housing 2.

The cable assembly 1 is used in this way to arrange only the portion between the seal caps 30 outside the housings 2. As described above, at the portion between the seal caps 30, the cables 10 are surrounded by the water-proof tube 20, and the ends of the water-proof tube 20 cover the seal caps 30 water-tight. Further, a portion between the housing 2 and the seal cap 30 is sealed by the O ring 38 water-tight. Thus, penetration of water from an outside to an inside of the housings 2 is prevented.

Further, the convex portions 34 of the seal caps 30 fit to the cutout portions of the housings 2, so that it is possible to prevent the cable assembly 1 from rotating with respect to the housings 2 and fix the orientation of the connectors 50 in the housings 2.

Next, a method of manufacturing the cable assembly 1 will be described.

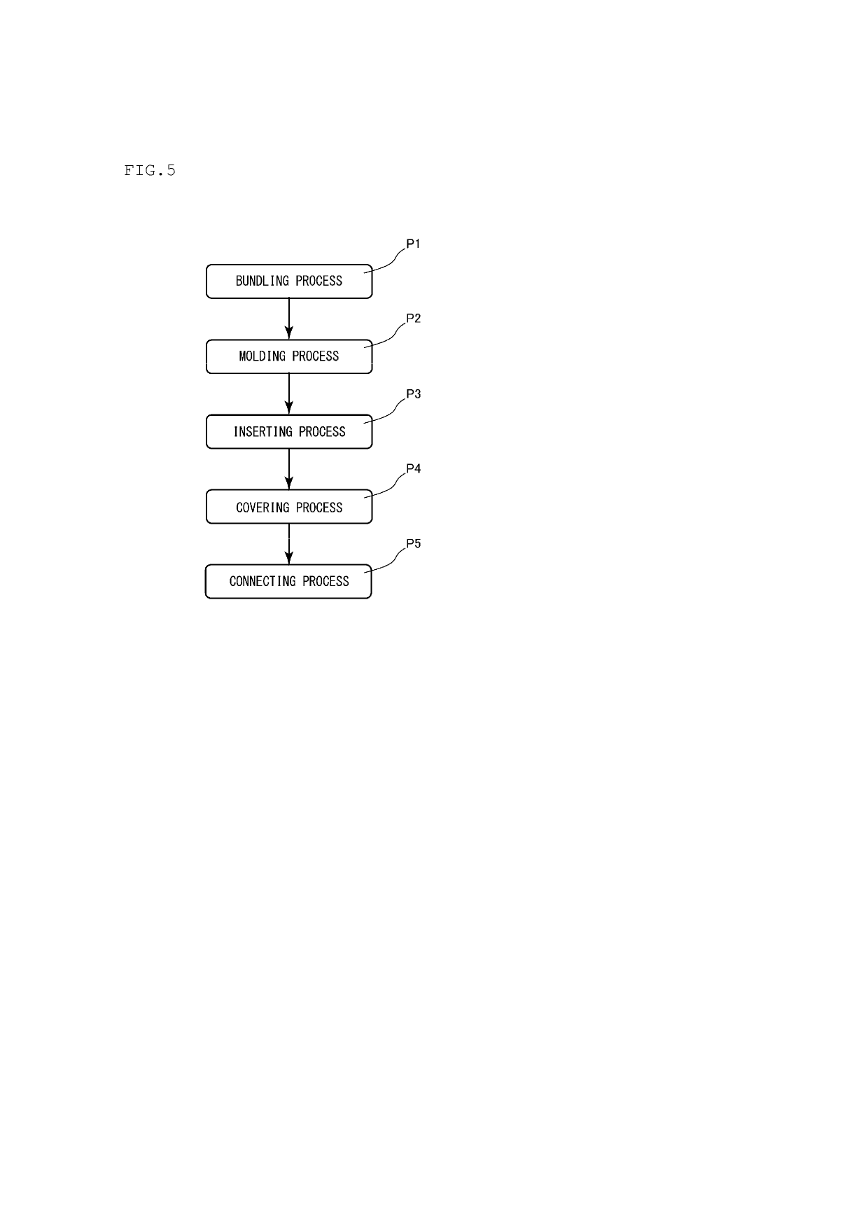

FIG. 5 is a flowchart illustrating a process of a method of manufacturing the cable assembly 1 according to the present embodiment. As illustrated in FIG. 5, the method of manufacturing the cable assembly 1 according to the present embodiment mainly includes: a bundling process P1 of bundling a plurality of cables 10; a molding process P2 of providing a pair of seal caps 30 on the outer peripheral surfaces of the plurality of bundled cables 10; an inserting process P3 of inserting a portion of the plurality of cables 10 between the seal caps 30 in penetration holes of the water-proof tube 20; a covering process P4 of covering the seal caps 30 by the both ends of the water-proof tube 20 water-tight; and a connecting process P5 of connecting the connectors 50 to the both ends of the plurality of cables 10.

<Bundling Process P1>

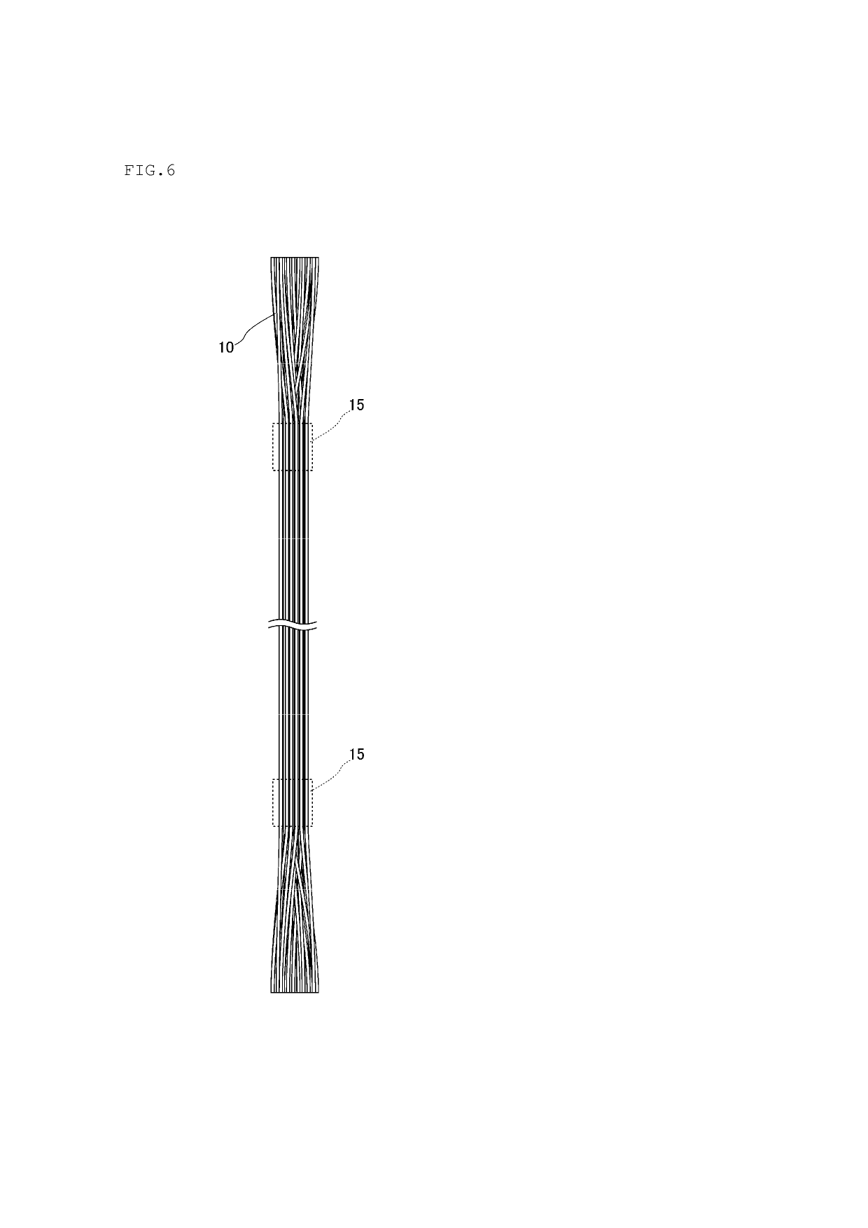

First, a plurality of cables 10 is prepared and bundled. Thus, a plurality of cables is bundled as illustrated in FIG. 6. In addition, in this case, the cables are bundled such that at least sites 15 at which the seal caps 30 are provided have the smallest diameters. Further, a plurality of cables 10 bundled in a mold which is not illustrated are fixed.

<Molding Process P2>

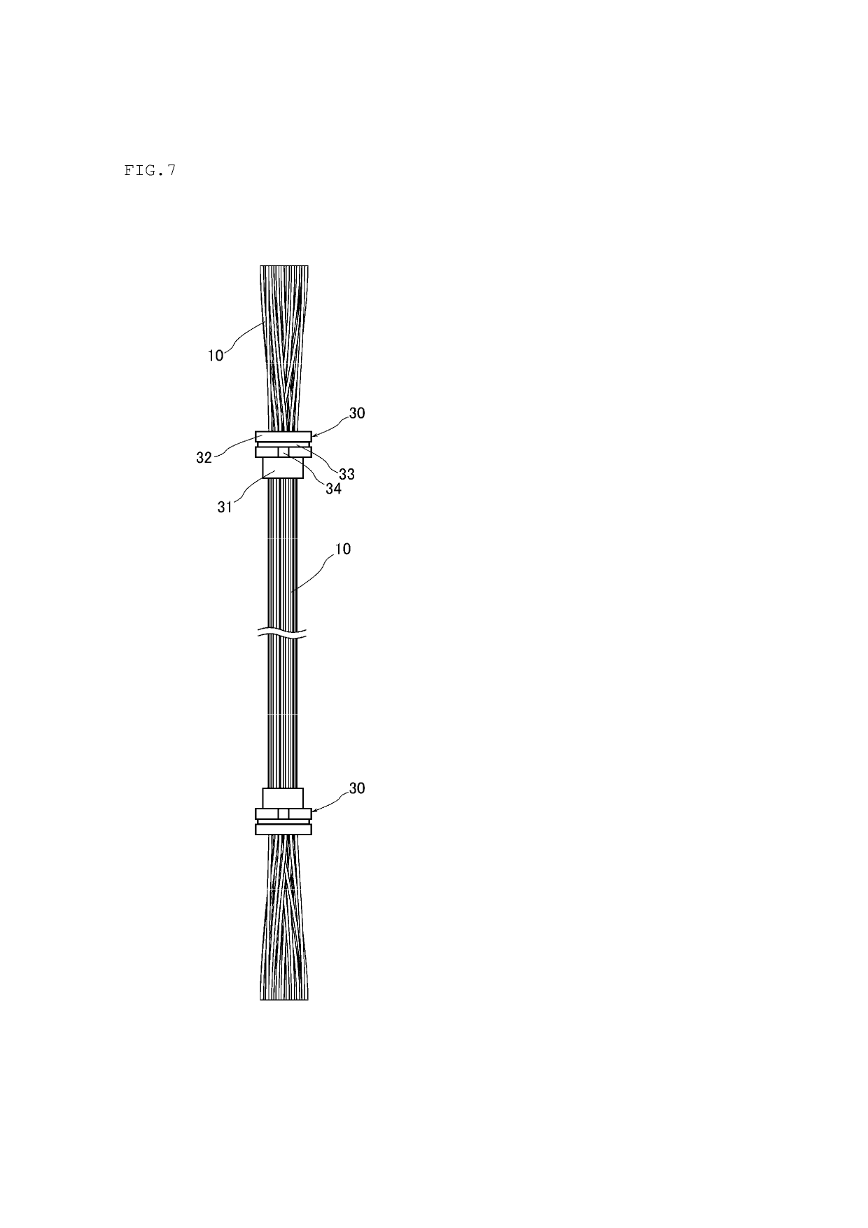

Next, a pair of seal caps 30 is provided on outer peripheral surfaces of a plurality of cables 10 fixed to the mold by way of insertion molding. Thus, as illustrated in FIG. 7, a pair of seal caps 30 is provided to a plurality of cables 10. By forming the seal caps 30 by way of insertion molding, little clearance is produced between a plurality of cables 10 and the seal caps 30 as illustrated in FIGS. 2 and 3.

<Inserting Process P3>

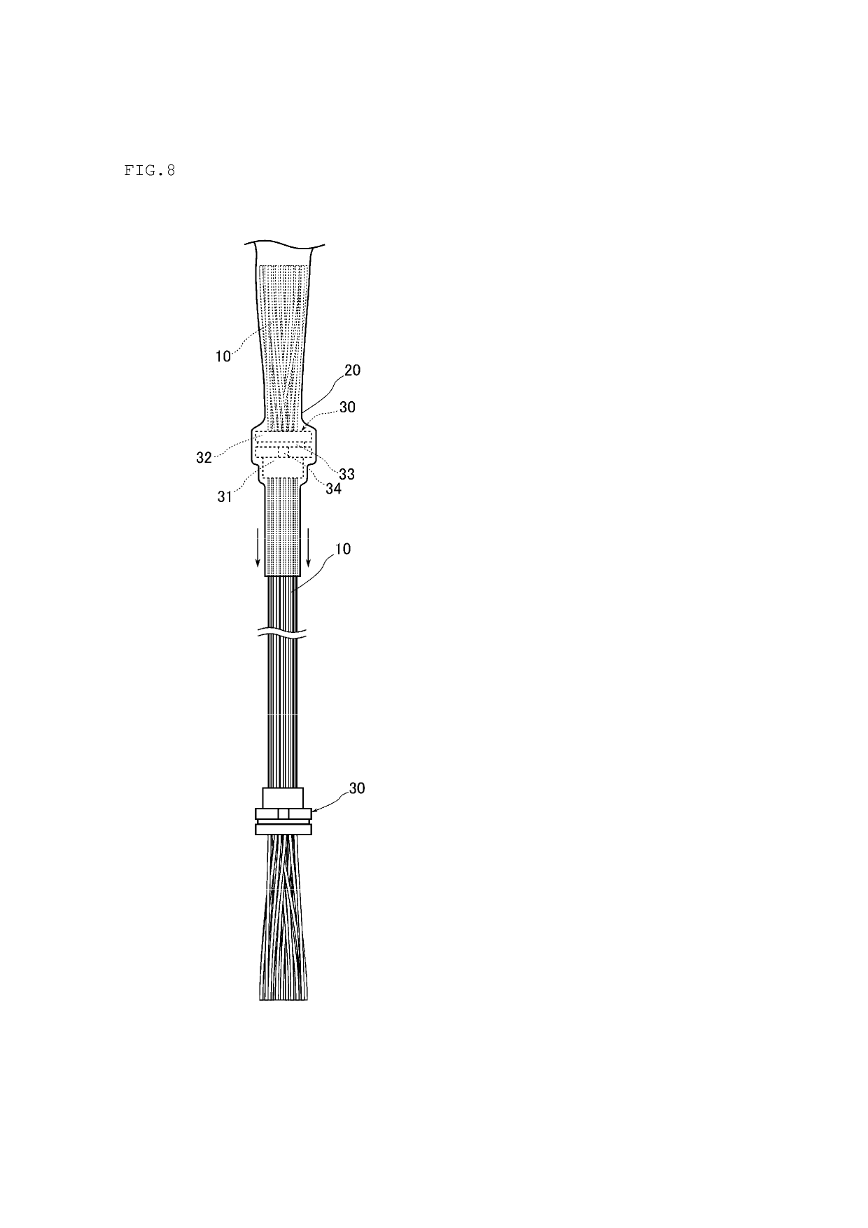

Next, a portion of a plurality of cables 10 between a pair of seal caps 30 is inserted in penetration holes of the water-proof tube 20. More specifically, as illustrated in FIG. 8, one side of a plurality of cables 10 is inserted in the penetration hole of the water-proof tube 20, and the water-proof tube 20 is moved to the portion between a pair of seal caps 30. In this case, when the water-proof tube passes over seal cap 30, the water-proof tube 20 is moved by being stretched such that the inner diameter of the water-proof tube 20 becomes large.

<Covering Process P4>

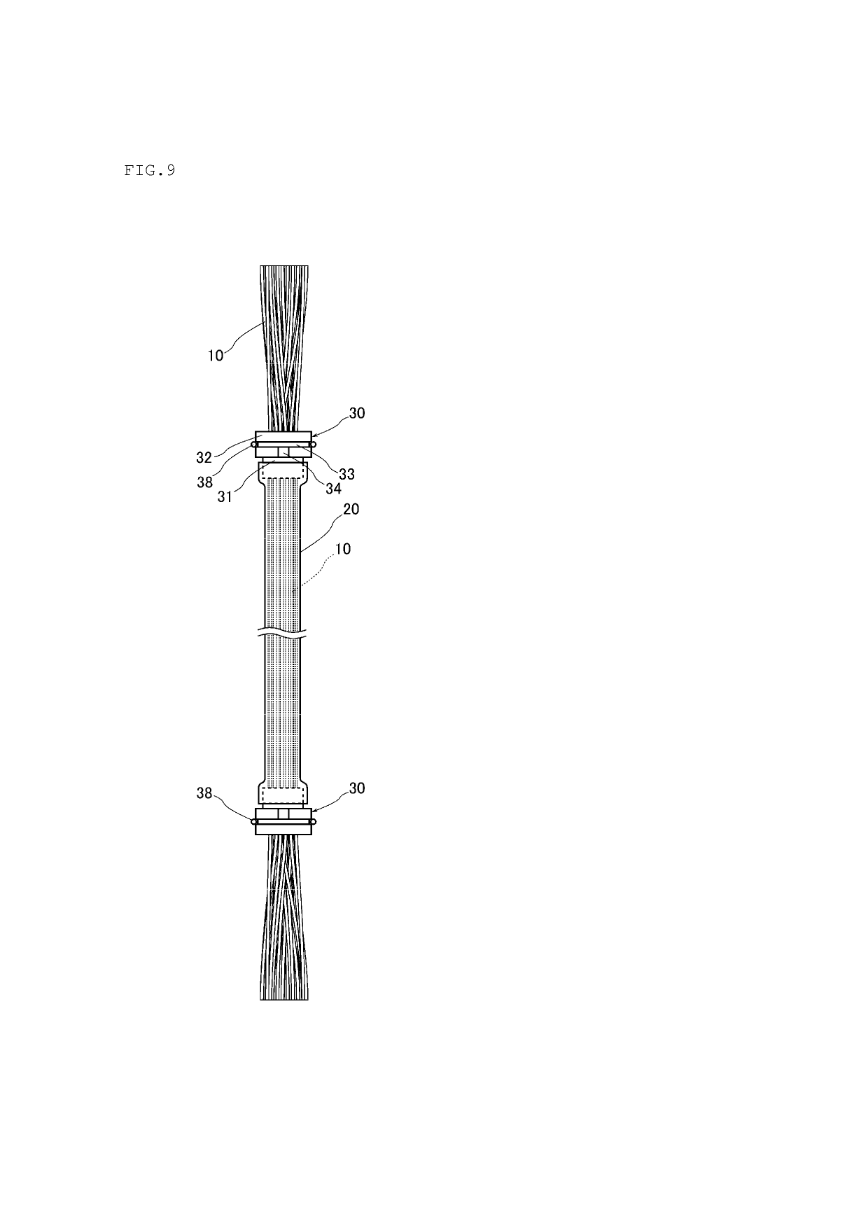

Next, the both ends of the water-proof tube 20 in which a plurality of cables 10 are inserted cover the small diameter portions 31 of the seal caps 30. In this case, when the seal caps 30 and the water-proof tube 20 are adhered by the adhesive which is not illustrated, the adhesive is applied to the small diameter portions of the seal caps 30 in advance. Thus, as illustrated in FIG. 9, the portion of a plurality of cables 10 between the seal caps 30 is inserted in the penetration holes of the water-proof tube 20, and the both ends of the water-proof tube 20 cover the seal caps 30 water-tight. In addition, after the inserting process P3 or after the covering process P4, the O rings 38 are attached to the groove portions 33 of the seal caps 30.

<Connecting Process P5>

Next, the both ends of the cables 10 are connected to the connectors 50. More specifically, the center conductors of the cables 10 are connected to the terminals of the connectors 50. Further, when the cables 10 are the coaxial cables, the outer conductors are connected to the predetermined terminal of the connectors 50. Thus, the cable assembly 1 illustrated in FIG. 1 is obtained.

As described above, in the cable assembly 1 manufactured by the method of manufacturing the cable assembly according to the present embodiment, the cables 10 between a pair of seal caps 30 are inserted in the water-proof tube 20 which covers the seal caps 30 water-tight as described above and has the water cutoff property. Consequently, even when the portion between the seal caps 30 is exposed to water, it is possible to prevent water from proceeding between the cables 10 and penetrating toward the connectors 50. Further, a pair of seal caps 30 is provided to a plurality of bundled cables 10 by way of insertion molding, so that little clearance is produced between the seal caps 30 and the cables 10. Consequently, compared to tubular seal caps which are molded in advance and in penetration holes of which a plurality of cables is inserted, the seal caps 30 can be made smaller. Consequently, even when the housings have small insertion holes of the cable assembly 1, it is possible to insert the seal caps 30 in the penetration holes of the housings, and attach the seal caps to the housings. In other words, by using the cable assembly 1 manufactured by this method of manufacturing the cable assembly, it is possible to make the insertion holes 80 of the cable assembly 1 in the housings 2 smaller. Consequently, by inserting air-tight the seal caps 30 in the insertion holes 80 of the housings 2 which are formed small, it is possible to realize a small and water-proof electronic device.

### Second Embodiment

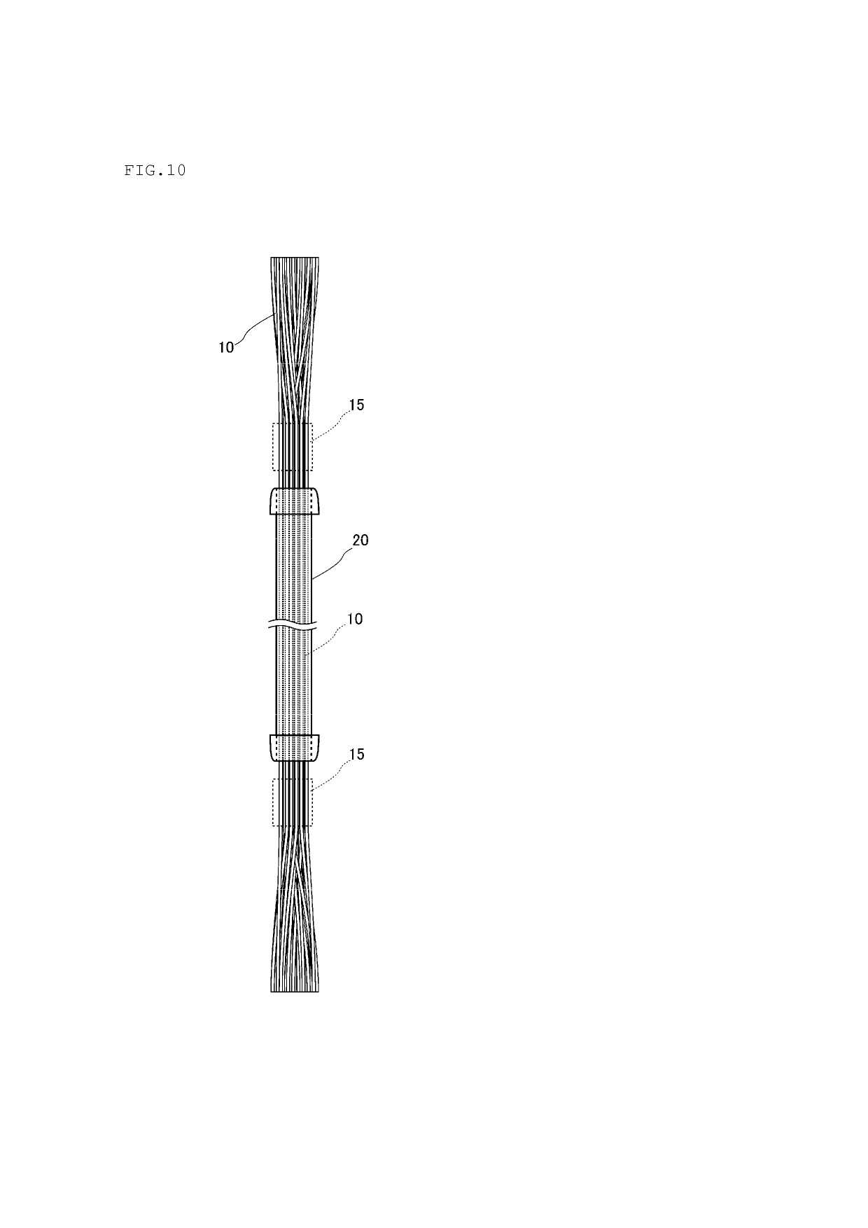

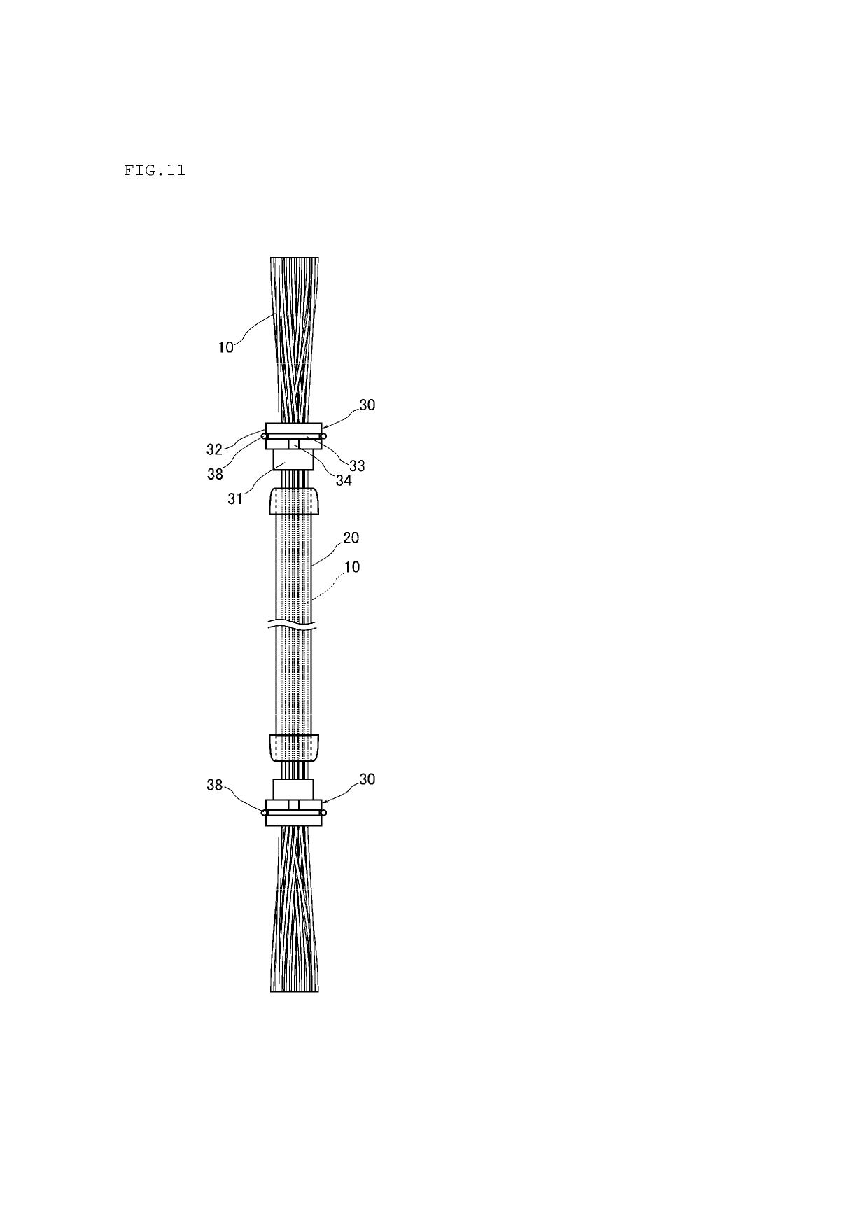

Next, a second embodiment of the present invention will be described in detail with reference to FIGS. 10 and 11. In addition, the same or equivalent components as those of the first embodiment will be assigned the same reference numerals and will not be described unless described in particular.

A method of manufacturing a cable assembly 1 according to the present embodiment differs from a method of manufacturing the cable assembly 1 according to the first embodiment in performing an inserting process P3 between a bundling process P1 and a molding process P2.

In the method of manufacturing the cable assembly 1 according to the present embodiment, the bundling process P1 is first performed similar to the first embodiment.

Next, the inserting process P3 is performed. That is, a plurality of bundled cables 10 are inserted in penetration holes of a water-proof tube 20. In addition, upon the next molding process P2, both ends of the water-proof tube 20 are folded such that the water-proof tube 20 is not bothersome to prevent sites 15 of a plurality of bundles cables 10 at which seal caps 30 are provided from being surrounded by the water-proof tube 20. Thus, as illustrated in FIG. 10, a plurality of cables 10 are inserted in penetration holes of the water-proof tube 20. In addition, the sites 15 at which the seal caps 30 are provided may not be surrounded by the water-proof tube 20 by a method of, for example, contracting the water-proof tube 20.

Next, the molding process P2 is performed. That is, at both ends of the water-proof tube 20, a pair of seal caps 30 is provided on outer peripheral surfaces of the plurality of cables 10 by way of insertion molding. In this case, if the both ends of the water-proof tube 20 are folded as described above, the water-proof tube 20 is not bothersome upon insertion molding and is preferable. Further, after the molding process, O rings 38 are attached to groove portions 33 of the seal caps 30. Thus, as illustrated in FIG. 11, at both ends of the water-proof tube 20, a pair of seal caps 30 is provided on outer peripheral surfaces of the plurality of cables 10.

Next, when the both ends of the water-proof tube 20 are folded, the both ends are unfolded to the original state, a covering process P4 is performed in the same manner as the first embodiment and then the connecting process P5 is performed. Thus, the cable assembly 1 illustrated in FIG. 1 is obtained.

This method of manufacturing the cable assembly according to the present embodiment can also manufacture the cable assembly 1 which has the water cutoff property and insertion holes of which can be attached to small housings. Further, a plurality of cables 10 are inserted in penetration holes of the water-proof tube 20 before the seal caps 30 are provided, so that a plurality of cables 10 can be easily inserted through the water-proof tube 20 without inserting a plurality of cables 10 through the water-proof tube 20 such that the water-proof tube 20 goes over the seal caps 30. Consequently, it is possible to reduce a load on the water-proof tube 20.

### Third Embodiment

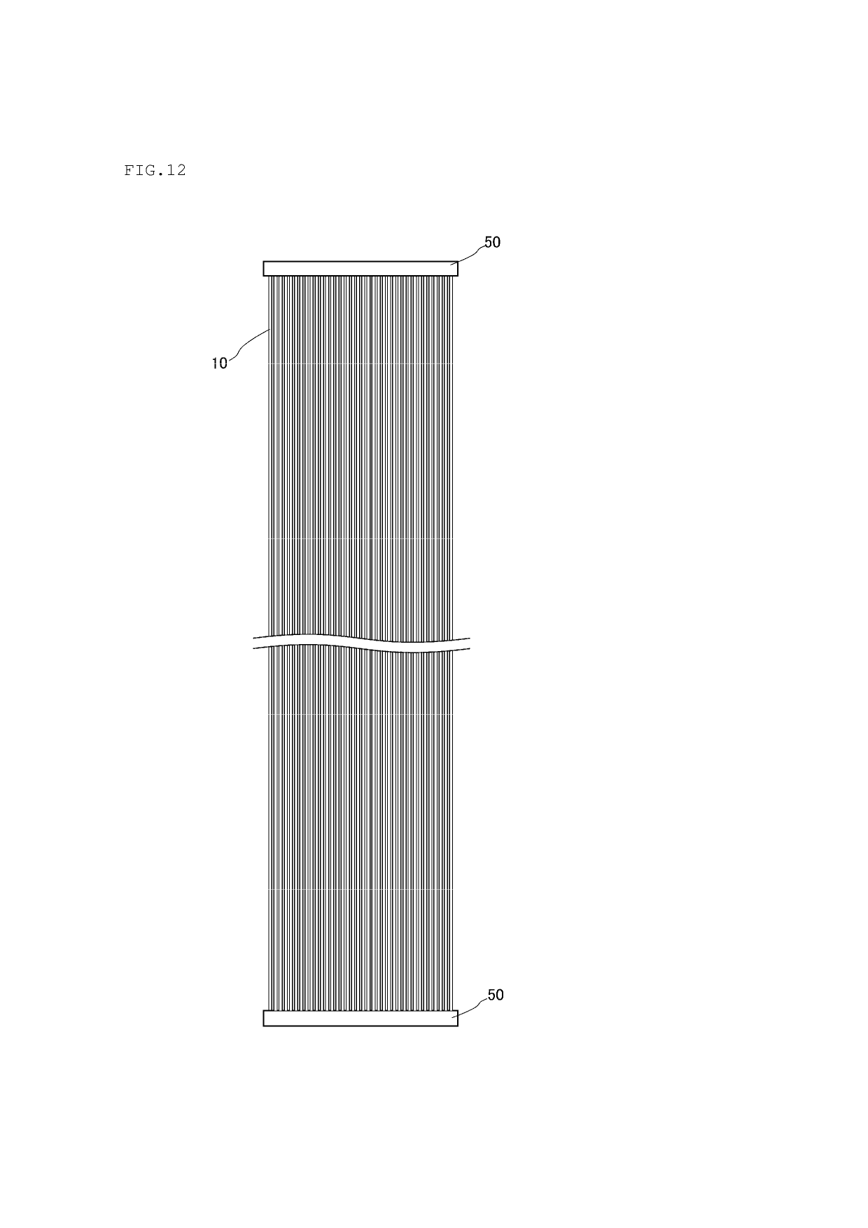

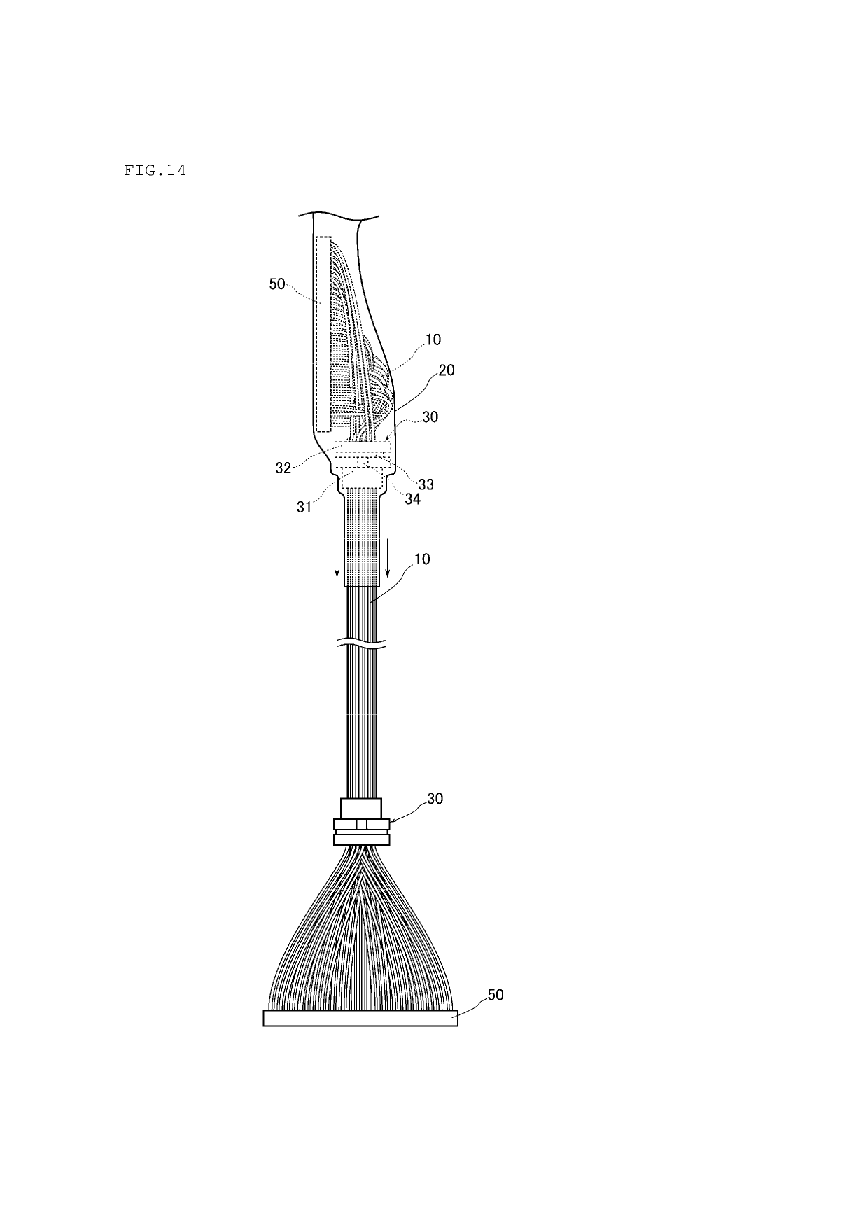

Next, a third embodiment of the present invention will be described in detail with reference to FIGS. 12 and 14. In addition, the same or equivalent components as those of the first embodiment will be assigned the same reference numerals and will not be described unless described in particular.

A method of manufacturing a cable assembly 1 according to the present embodiment differs from a method of manufacturing the cable assembly 1 according to the first embodiment in performing a connecting process P5 before a bundling process P1.

In the method of manufacturing the cable assembly 1 according to the present embodiment, the connecting process P1 is first performed. That is, a plurality of cables 10 is prepared and both ends of the cables 10 are connected to connectors 50. In this case, the cables 10 need to be connected to the connectors in the same method as that of the first embodiment. Thus, as illustrated in FIG. 12, both ends of the cables 10 are connected to the connectors.

Next, the bundling process P1 is performed. In the bundling process P1, the both ends of the cables 10 have been connected to the connectors, and at least sites which seal caps 30 are provided are bundled. Further, a plurality of bundled cables 10 are fixed to a mold which is not illustrated.

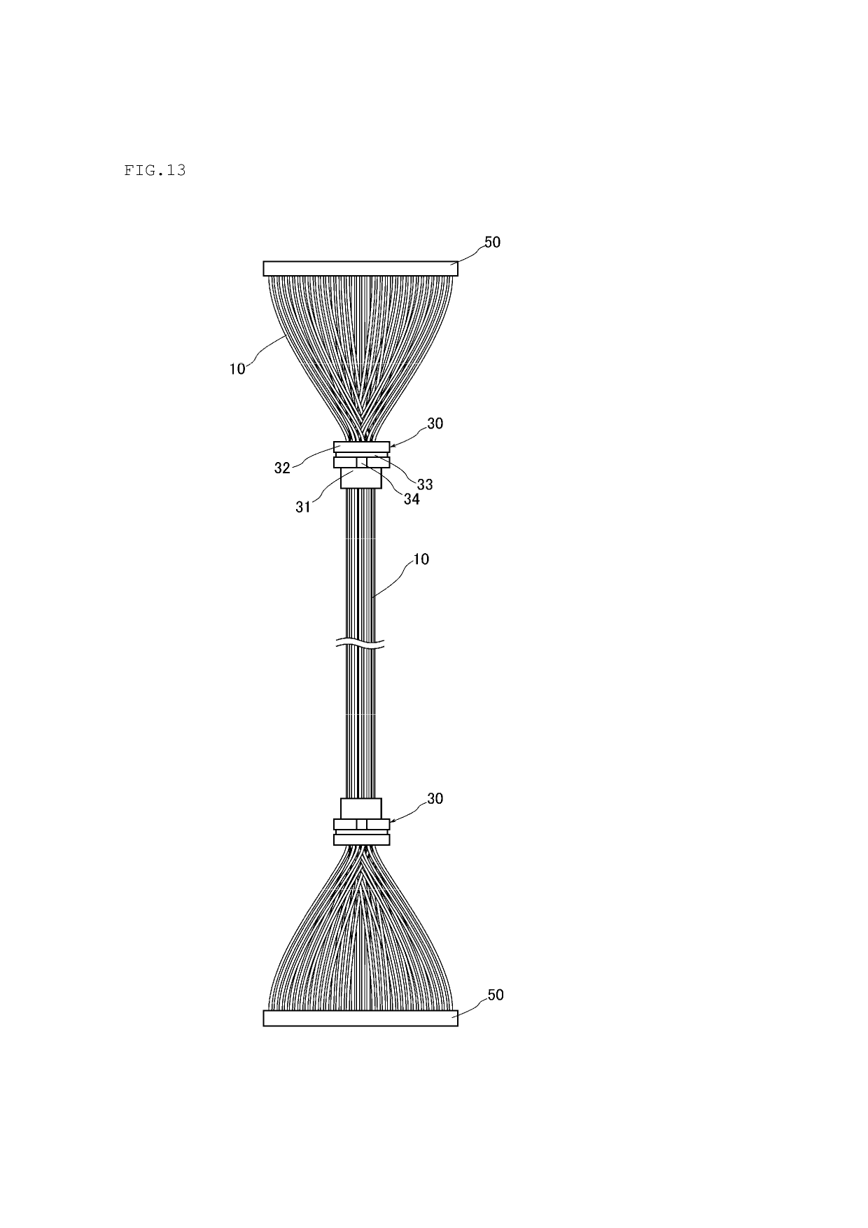

Next, a molding process P2 is performed. The seal caps 30 are provided by way of insertion molding similar to the first embodiment. Thus, as illustrated in FIG. 13, a pair of seal caps 30 is provided on outer peripheral surfaces of a plurality of cables 10 of which both ends are connected with the connectors 50.

Next, an inserting process P3 is performed. As illustrated in FIG. 14, in the inserting process P3, a water-proof tube 20 is stretched in a radial direction such that an inner diameter of the water-proof tube 20 widens, one connector 50 is inserted in a penetration hole of the water-proof tube 20, the water-proof tube 20 is moved to a portion between the seal caps 30 and the portion of a plurality of cables 10 between the seal caps 30 is inserted in the penetration holes of the water-proof tube 20. In this case, the connectors 50 are tilted where necessary to facilitate insertion of the connectors 50 in the penetration holes of the water-proof tube 20. Further, the water-proof tube 20 is moved to the portion between a pair of seal caps 30.

Then, a covering process P4 is performed similar to the first embodiment. In addition, after the inserting process P3 or after the covering process P4, O rings 38 are attached to groove portions 33 of the seal caps 30. Thus, the cable assembly 1 illustrated in FIG. 1 is obtained.

With the method of manufacturing the cable assembly according to the present embodiment, the cables 10 are connected to the connectors 50 in a state where a plurality of cables 10 are not bundled, so that it is easy to distinguish between the cables in the connecting process P5 and it is possible to prevent incorrect connection.

Although the present invention has been described using the first to third embodiments as examples above, the present invention is by no means limited to these.

Although, for example, the connecting process P5 is performed before the bundling process P1 in the third embodiment, the present invention is not limited to this and the connecting process P5 may be performed between the bundling process P1 and the molding process P2. In this case, while a plurality of cables 10 are bundled, the cables 10 are connected to the connectors 50 before the seal caps 30 are provided, so that the seal caps 30 are not bothersome in the connecting process P5 and prevent incorrect connection.

Further, although a configuration has been employed with the first embodiment where convex portions 34 are provided on part of outer peripheral surfaces of large diameter portions 32 of the seal caps 30, concave portions may be provided instead of the convex portions 34. In this case, convex portions to which the concave portions of the seal caps 30 can fit only need to be formed in inner wall surfaces of insertion holes 80 of housings 2. Alternatively, part of the large diameter portions 32 may be, for example, polygonal. That is, preferably, at least portions of the seal caps 30 which are not covered by the water-proof tube 20 are provided with the convex portions or the concave portions are provided or are made polygonal to make cross-sectional shapes of outer peripheral surfaces of the seal caps 30 in a direction vertical to the longitudinal direction non-circular. By so doing, it is possible to prevent the cable assembly 1 from rotating with respect to the housings 2, and fix the orientation of the connectors 50 in the housings 2.

Further, when it is not necessary to prevent the cable assembly 1 from rotating with respect to the housings 2 or another unit prevents the cable assembly 1 from rotating with respect to the housings 2, vertical cross sections of all outer peripheral surfaces of the seal caps 30 in the longitudinal direction may be circular.

Furthermore, although, in the first to third embodiments, the cable assembly 1 employs a configuration including the O rings 38, the O rings are not indispensable configurations. When, for example, the seal caps 30 fit to the insertion holes 80 of the housings 2 without gaps, the O rings 38 can be removed.

### INDUSTRIAL APPLICABILITY

The present invention provides a cable assembly manufacturing method of manufacturing a cable assembly which has the water cutoff property and of which insertion holes can be attached to small housings.

### DESCRIPTION OF REFERENCE NUMERALS

1: CABLE ASSEMBLY
2: HOUSING
10: CABLE
20: WATER-PROOF TUBE
30: SEAL CAP
31: SMALL DIAMETER PORTION
32: LARGE DIAMETER PORTION
33: GROOVE PORTION
34: CONVEX PORTION
38: O RING
50: CONNECTOR
80: INSERTION HOLE
P1: BUNDLING PROCESS
P2: MOLDING PROCESS
P3: INSERTING PROCESS
P4: COVERING PROCESS
P5: CONNECTING PROCESS

1-5. (canceled)

6. A method of manufacturing a cable assembly comprising:
a bundling step of bundling a plurality of cables;
a molding step of providing a pair of seal caps on outer peripheral surfaces of the plurality of bundled cables by way of insertion molding;
an inserting step of inserting a portion of the plurality of cables between the seal caps in a penetration hole of a water-proof tube comprising a stretching property;
a covering step of covering the seal caps by the both ends of the water-proof tube water-tight; and
a connecting step of connecting connectors to the both ends of the plurality of cables.

7. A method of manufacturing a cable assembly comprising:
a bundling step of bundling a plurality of cables;
an inserting step of inserting a portion of the plurality of bundled cables in a longitudinal direction in a penetration hole of a water-proof tube comprising a stretching property;
a molding step of providing at both ends of the water-proof tube a pair of seal caps on outer peripheral surfaces of the plurality of bundled cables by way of insertion molding;
a covering step of covering the seal caps by the both ends of the water-proof tube water-tight; and
a connecting step of connecting connectors to the both ends of the plurality of cables.

8. The method of manufacturing the cable assembly according to claim 6, wherein the connecting step is performed prior to the molding step.

9. The method of manufacturing the cable assembly according to claim 8, wherein the connecting step is performed prior to the bundling step.

10. The method of manufacturing the cable assembly according to claim 6, wherein a cross-sectional shape of outer peripheral surfaces in at least a part of portions of the seal caps which are not covered by the water-proof tube is non-circular.

11. The method of manufacturing the cable assembly according to claim 7, wherein the connecting step is performed prior to the molding step.

12. The method of manufacturing the cable assembly according to claim 11, wherein the connecting step is performed prior to the bundling step.

13. The method of manufacturing the cable assembly according to claim 7, wherein a cross-sectional shape of outer peripheral surfaces in at least a part of portions of the seal caps which are not covered by the water-proof tube is non-circular.
